(19) United States
(12) Patent Application Publication
(10) Pub. No.: US 2026/0360230 A1
(43) Pub. Date: Nov. 12, 2026

(54) SIGNALING DEVICE WITH RIVET FASTENING BETWEEN SOUNDBOARD AND PIEZO ELEMENT

(71) Applicant: WERMA Holding GmbH + Co. KG, Rietheim-Weilheim (DE)

(72) Inventors: Dietmar Waizenegger, Muehlheim (DE); Felix Bechler, Tuttlingen (DE); Daniel Mueller, Villingendorf (DE); Gero Kuehnemundt, Emmingen-Liptingen (DE); Werner Stuffle, Spaichingen (DE)

(73) Assignee: WERMA Holding GmbH + Co. KG, Rietheim-Weilheim (DE)

(21) Appl. No.: 19/670,583

(22) Filed: May 7, 2026

(30) Foreign Application Priority Data
May 8, 2025 (DE) 10 2025 117 747.3

(51) Int. Cl. G08B 3/10; G10K 9/122

(52) U.S. Cl. CPC G08B 3/10; G10K 9/122

(57) ABSTRACT

An acoustic or partially acoustic or opto-acoustic signaling device (S) is proposed, for outputting at least one acoustic signal for indicating operating states of technical devices, machines, systems, vehicles or the like, comprising a soundboard (1) as housing section or mounting section. To implement production that is cost-effective and reliable with regard to the process, a piezo element (3) is provided, which has a recess (4) for fastening, wherein the soundboard (1) is provided with a rivet element (2, 7) and/or has a rivet element (2, 7) which passes through the recess (4) and is formed such that it fastens the piezo element (3) on the soundboard (1).

The invention relates to an acoustic or partially acoustic or opto-acoustic signaling device for outputting at least one acoustic signal for indicating operating states of technical devices, machines, systems, vehicles or the like.

A signaling device for optical and acoustic signals at machines, systems or buildings is known from the prior art, for example from EP 1 146 280B1, in which a piezo disk is centrally adhesively bonded to a membrane, so that the membrane can vibrate freely outside the holder for the piezo disk.

The object of the invention is to provide a signaling device which can be produced inexpensively, but nevertheless reliably with regard to the process.

The object is achieved, starting from a signaling device of the type mentioned in the introduction, by the characterizing features of claim 1 or claim 13 and, for a corresponding production method, by the features of claim 7.

Advantageous embodiments and developments of the invention are possible by way of the measures mentioned in the dependent claims.

The signaling device according to the invention is used for outputting an acoustic signal for indicating operating states of technical devices, machines, systems, vehicles or the like. It may nonetheless be an also optically operating signaling device, such as a signal lamp, which additionally outputs acoustic signals, for example warning signals, that is to say an opto-acoustic signaling device. The mechanical vibrations for generating the sound signal are initially generated by a piezo element. The piezo element in turn is mechanically coupled to a soundboard which constitutes a housing section or a mounting section. Then, the signaling device according to the invention is characterized in that the piezo element is provided with a recess, particularly with a hole, for example a through hole, which can be used for fastening. The fastening of the piezo element on the soundboard takes place by means of a rivet element which passes through the recess. In this case, the soundboard can be set vibrating due to the contact with the piezo element. If, in one embodiment, the soundboard adjoins a sound chamber, the sound signal can be amplified therein, as in a resonant cavity. Thus, the signaling device differs from the previous prior art, in which the piezo element is adhesively bonded to the soundboard. In principle, rivet element and adhesive bonded joint have two functions, namely the fastening of the piezo element and the mechanical coupling of the piezo element to the soundboard, in order to be able to transmit the mechanical vibrations. The invention therefore has the advantage that a rivet connection is considerably more reliable with regard to the process than an adhesive bonded joint, because the quality of the adhesive bonded joint depends on numerous parameters, starting from the quantity of adhesive, the thickness of the adhesive layer, the size and continuity of the adhesive bonded joint, etc. In addition, the quality of the adhesive layer depends on further parameters in the production, for example the conditions during drying or curing or other influences. In order to be able to configure an adhesive bonded joint in a reliable manner with regard to process, the production process would have to be configured in a considerably more complex manner. In general, it must even be assumed that an adhesive bonded joint is not stable long-term. Furthermore, an adhesive bonded joint between piezo element and soundboard constitutes a medium which on the one hand is used for the fastening, that is to say must be stable, but on the other hand is also exposed to mechanical loads due to the vibration transmission.

Due to the introduction of a recess, particularly a hole, into the piezo element, a mechanically stable mounting can be achieved; the piezo element can however primarily vibrate freely toward the edges. The recess or the hole can pass through the surface of the piezo element such that it is completely enclosed by the piezo element, i.e. the recess does not cut through the edge of the piezo element. It can advantageously be formed as a central hole, so that the piezo element can be arranged e.g. centrally in the signaling device and also the same vibration conditions prevail on all sides.

In a design variant of the invention, the piezo element can for example be formed as a piezo disk. It can have a cylindrical basic shape, so that the vibration also can be distributed symmetrically, especially in the case of a central hole.

The holder or bearing passes completely through the recess. It is formed as a rivet element. The rivet element can be manufactured from plastic. It can, depending on the embodiment, be formed in one piece together with the soundboard. It is however also conceivable that the rivet element is formed separately and anchored in the soundboard or fastened thereon in another way.

In a development of the invention, the rivet element can be partially melted and reshaped for fixing on the soundboard, in order to produce a positive and/or non-positive connection to the piezo element. Such a procedure can advantageously be achieved in a reproducible, quick and stable manner during production by means of heat staking of the rivet element or the rivet head. The rivet element then passes through the recess of the piezo element and secures it in the lateral direction. Perpendicularly to planes of the recess opening, the rivet element can be widened so greatly that the shaped rivet element or the rivet head no longer fits through the recess. In particular, the rivet element can surround the edge of the recess.

Due to the partial melting, the rivet head or the end section of the rivet element can partially adapt to the shape of the piezo element in the region of the recess. Due to the partial melting, a non-positive connection can also be produced, in which the rivet element presses against the recess and/or the piezo element presses against the soundboard.

In order to also ensure the stability long-term, even in the event of vibration of the piezo element, the rivet element can cover the edge region of the recess partially or completely. Especially in the case of relatively large recesses, it is possible in corresponding exemplary embodiments of the invention for a rivet ring to also be used as rivet element in a material saving manner.

The rivet element does not absolutely have to be partially melted as a whole. It may be sufficient only to partially melt the exposed end of the rivet element. The reshaped part forms a kind of head of the rivet element, the rivet head. The rivet element then has a for the most part mushroom-shaped form.

Accordingly, in the production method according to the invention, a soundboard is initially provided. The soundboard can be a housing section or a mounting section, i.e. the soundboard is part of a section essentially intended for the mounting of the signaling device. A sound chamber may adjoin the soundboard, so that the soundboard generates a vibration which is amplified by resonance in the sound chamber. In addition, a rivet element is provided, wherein soundboard and rivet element can be formed in one piece, in order in particular to be able to save on a further mounting step.

Furthermore, a piezo element, e.g. a piezo disk, is provided, which has a recess or a hole. The piezo element is positioned such that the rivet element passes through the recess completely.

For the subsequent partial melting of the rivet element, this rivet element is heat staked, i.e. the rivet element is at least partially melted and reshaped, so that it holds the piezo element on the soundboard and/or has a larger extent than the recess. Such a production method according to the invention can be applied in a cost-effective manner, but also a reliable manner with regard to the process.

In a design variant, the heat staking of the rivet element can be realized using a thermode which heats up and is brought into contact with the rivet element, that is to say e.g. is pressed against the rivet element. The rivet element, which previously could still be pushed through the recess in the unshaped state, is partially melted and reshaped, so that it is wider than the recess and no longer fits through. It may encompass or surround the edge of the recess. In order to obtain a secure and stable hold, the reshaping can take place to such an extent that the rivet head bears in a positive and/or non-positive manner against the piezo element. A materially bonded connection, as in the case of adhesive bonding, can be avoided in order to be able to use a method that is more reliable with regard to the process.

The temperature of the thermode can be actively controlled during heat staking, in order to obtain an optimum result and to reduce the processing time. It can therefore also be adapted to various materials as production material.

Instead of a thermode, the heat staking can also take place contactlessly by means of a laser or by means of infrared radiation. Especially using a laser, a very precise, positionally accurate heating can take place. In the case of contactless heat staking, it is possible to improve the susceptibility to maintenance, because no residues remain adhered around the tool.

The rivet element can be formed in a mushroom-shaped manner, wherein the mushroom head is partially melted and shaped by heating or heat staking. In one embodiment, the rivet element can be provided with a rivet head as small, compact unit, in order to be reshaped to form the holding element in the case of small recesses. In the case of relatively large recesses, a relatively large rivet ring can however also be used, which rivet ring can surround the edge of the recess in an encompassing manner.

The signaling device according to the invention can in principle however also be produced in this manner in a reliable manner with regard to process by other production methods.

### EXEMPLARY EMBODIMENTS

Exemplary embodiments of the invention are illustrated in the drawings and will be explained in more detail below with further details and advantages being set forth. In the figures:

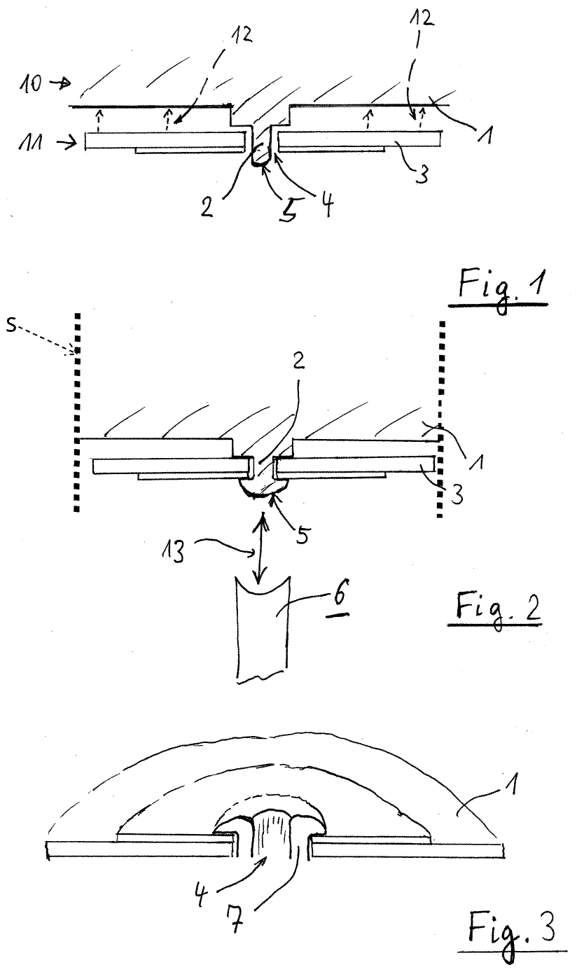

FIG. 1 shows a section through a soundboard 1 which has a mushroom-shaped rivet element 2. A piezo disk 3, which is provided with a centrally arranged hole 4, is placed onto the soundboard 1 such that the rivet element 3 passes through the hole 4 in the piezo disk 3 completely. The rivet head 5 of the rivet element 2 likewise fits through the hole 4.

Thus, FIG. 1 shows the provision 10 of a soundboard 1 which is formed in one piece together with a rivet element 2, and also the provision 11 of a piezo disk 3 and the placement 12 thereof on the soundboard 1, so that the rivet element 2 passes through the hole 4.

Additionally shown in FIG. 2 is the thermode 6, which has been pressed against the rivet head 5, whilst the piezo disk is furthermore arranged on the soundboard 1 such that the rivet element 2 passes through the hole 4. This process is referred to as heat staking 13. It is indicated that the soundboard 1 is inserted into the signaling device S. One of the regions adjoining the soundboard 1 can form the sound chamber for amplifying the sound signal.

FIG. 3 shows a schematic illustration of a rivet ring 7 which holds the piezo disk 3. The reshaped rivet ring 7 encompasses the edge of the comparatively large recess 4. Also, the rivet ring 7 here surrounds the edge of the recess 4 completely.

It is common to all embodiments and developments of the invention that a piezo element is provided, which has a recess for fastening, wherein the soundboard is provided with a rivet element and/or has a rivet element which passes through the recess and is formed such that it fastens the piezo element on the soundboard. As a result, the in-line production can advantageously take place in the cycle time, because the additional time for an adhesive bonding procedure, in particular the drying time, is dispensed with. In addition, less material can be wasted, because there are in principle always residues of plastic that get caught left over during production. In addition, it is possible to dispense with a buffer store at the work spaces. Overall, a higher process reliability is possible, especially with the heat staking. The manufactured parts can be produced more uniformly; scrap can be reduced.

### LIST OF REFERENCE SIGNS

1 Soundboard
2 Rivet element
3 Piezo disk
4 Hole/recess
5 Rivet head
6 Thermode
7 Rivet ring
10 Provision of a soundboard with rivet element
11 Provision of a piezo element
12 Positioning of the piezo element on the soundboard
13 Heat staking
S Signaling device

1. Acoustic or partially acoustic signaling device (S) for outputting at least one acoustic signal for indicating operating states of technical devices, machines, systems, vehicles or the like, particularly an opto-acoustic signaling device (S), comprising a soundboard (1) as housing section or mounting section, characterized in that a piezo element (3) is provided, which has a recess (4) for fastening, wherein the soundboard (1) is provided with a rivet element (2, 7) and/or has a rivet element (2, 7) which passes through the recess (4) and is formed such that it fastens the piezo element (3) on the soundboard (1).

2. Signaling device (S) according to claim 1, characterized in that
a. the piezo element (3) is formed as a piezo disk and/or in a cylindrical basic shape, and/or
b. the recess (4) is formed in the piezo element (3) as a hole (4), in particular as a central hole (4).

3. Signaling device (S) according to any one of the preceding claims, characterized in that the soundboard (1) is formed in one piece with the rivet element (2, 7) or in that soundboard and rivet element is/are formed as separate components from one another.

4. Signaling device (S) according to any one of the preceding claims, characterized in that the rivet element (2, 7):
a. is partially melted and reshaped in order to produce a connection, in particular a positive and/or non-positive connection, to the piezo element (3), and/or
b. is formed as a rivet head (5) or rivet ring (7), and/or
c. has a rivet head (5).

5. Signaling device (S) according to any one of the preceding claims, characterized in that the rivet element (2, 7) covers the edge region of the recess (4) at least partially or completely.

6. Method for production of an acoustic or partially acoustic or opto-acoustic signaling device (S) for outputting at least one acoustic signal for indicating operating states of technical devices, machines, systems, vehicles or the like, comprising:
a. providing (10) a soundboard (1) as housing section or mounting section,
b. providing a piezo element (3), which has a recess (4) for fastening,
c. providing (10) a rivet element (2, 7),
d. positioning (11) the piezo element (3) on the soundboard (1) so that the rivet element (2, 7) passes through the recess (4) of the soundboard (1),
e. heat staking (13) the rivet element (2, 7), wherein the rivet element (2, 7) is partially melted and reshaped, so that it holds the piezo element (3) on the soundboard (1) and/or that it covers the edge region of the recess (4) at least partially or completely.

7. Method for production according to claim 6, characterized in that soundboard (1) and rivet element (2, 7) are provided as a one-piece component.

8. Method for production according to claim 6 or 7, characterized in that the heat staking (13) of the rivet element (2, 7) takes place by means of contact with a thermode (6) for heating and shaping the rivet element (2, 7).

9. Method for production according to any one of claims 6-8, characterized in that the heat staking (13) of the rivet element (2, 7) takes place contactlessly by means of a laser or an infrared radiator for heating and shaping the rivet element.

10. Method for production according to any one of claims 6-9, characterized in that a rivet head (5) or rivet ring (7) is used as rivet element (2, 7).

11. Method for production according to any one of claims 6-10, characterized in that a positive and/or non-positive connection is produced between rivet element (2, 7) and piezo element (3), wherein preferably no materially bonded connection, in particular no adhesive bonded joint is produced between the soundboard (1) and the piezo element (3).

12. Acoustic or partially acoustic or opto-acoustic signaling device (S) for outputting at least one acoustic signal for indicating operating states of technical devices, machines, systems, vehicles or the like, which can be obtained by means of a method according to any one of claims 6-11.
